(19) United States
(12) Patent Application Publication
(10) Pub. No.: US 2014/0265314 A1
(43) Pub. Date: Sep. 18, 2014

(54) QUICK CONNECT COUPLER RAPID DISENGAGEMENT EXTENSION MECHANISM

(71) Applicant: Silicon Graphics International Corp., Milpitas, CA (US)

(72) Inventors: Russell Eric Stacy, Chippewa Falls, WI (US); Erik Konrad Peterson, Bloomer, WI (US)

(73) Assignee: Silicon Graphics International Corp., Milpitas, CA (US)

(21) Appl. No.: 13/860,465

(22) Filed: Apr. 10, 2013

Related U.S. Application Data
(60) Provisional application No. 61/782,873, filed on Mar. 14, 2013.

(51) Int. Cl. F16L 37/084

(52) U.S. Cl. CPC F16L 37/0841
USPC 285/308

(57) ABSTRACT

A coupler engagement mechanism includes a female member that detachably couples to a corresponding male member. The female member may include a central axis opening and a telescopically slidable outer sleeve. The outer sleeve may be spring-biased in a forward direction towards the central axis opening. A pull member may be coupled to the outer sleeve and may extend from the outer sleeve in a direction other than parallel to the radius of the outer sleeve.

### CROSS REFERENCE TO RELATED APPLICATIONS

This application claims the priority benefit of U.S. Provisional Application Ser. No. 61/782,873, titled “QUICK CONNECT COUPLER RAPID DISENGAGEMENT EXTENSION MECHANISM,” filed Mar. 14, 2013, the disclosure of which is incorporated herein by reference.

### BACKGROUND

1. Field of the Invention

The present invention relates to couplers. More specifically, the present invention relates to a quick-connect coupler engagement mechanism.

2. Description of the Related Art

Quick connect couplers are often used in fluid or gas transfers systems. Quick connect couplers allow two components to be coupled together without the use of a tool. They also automatically prevent fluid or gas from spilling when disengaged. Quick connect couplers typically include a male member and a female member. FIG. 1A illustrates a quick release coupler and a socket disengaged. In FIG. 1A, male member 110 is commonly attached to a system component, such as a manifold, while the female member 120 is commonly attached to an external component, such as a hose or pipe. The male member may include a central axis tip 115 with a circumferential groove. The female member may include a central axis opening 127 and a telescopically slidable outer sleeve 125.

The telescopically slidable sleeve is usually spring loaded to be in a forward position towards the opening, but is obstructed from moving forward until it is engaged with the male coupler. When the male coupler is inserted into the female coupler, the internal poppet mechanism is engaged and allows fluid to flow. At the same time, the telescopically slidable sleeve is freed to move forward and effectively lock the two couplers together until such time that the sleeve is mechanically retracted. When the sleeve is mechanically retracted, it frees the male coupler and the internal poppet mechanism is disengaged effectively stopping fluid from flowing and preventing any leaks.

The male and female members are typically coupled by pushing the opening of the female member onto the tip of the male member which engages the internal poppet mechanism, allowing fluid to flow, and allowing the outer sleeve to move forward and lock the two couplers together.

FIG. 1B illustrates a quick release coupler and a socket partially disengaged. As shown, the outer sleeve is retracted a bit and the tip of the male member is engaging the outer surface of the central axis opening. In FIG. 1C, the tip 115 (not visible or labeled in FIG. 1C) of the male member has been completely inserted into the central axis opening, and the outer sleeve 125 has been released to a forward at rest position over the tip 115. The members are usually disengaged from one another by manually gripping the outer sleeve and applying a rearward force to retract it. For purposes of describing the present invention herein, the terms “rearward” or “rearwardly” shall refer to a direction away from the opening of the female member.

Quick connect couplers are commonly used in liquid cooling systems for computer enclosures, such as blade server enclosures. Liquid cooling systems generally include a thermally conductive cold plate that draws heat from a central processing unit (CPU), a manifold and hose assembly that transports fluid through the cold plate, a pump to circulate the fluid, several external hoses that connect the pump to the manifold and hose assembly, and an external heat exchanger to dissipate heat. After the cold plate draws heat off of the CPU, it transfers the heat into the fluid running through the hoses. As the fluid then travels through the cold plate and external hoses, it carries the heat away from the enclosure to the heat exchanger. The heat exchanger then dissipates the heat safely outside the enclosure. FIG. 2 illustrates a blade server enclosure connected to hoses utilizing a quick release connection mechanism. As shown in FIG. 2, a blade enclosure 220 may have several external hoses 210 for carrying liquid from one portion of the enclosure to another, such as from the manifold to each individual blade and back to the manifold.

With blade server enclosures, any time a new blade server is installed into the enclosure, the new blade must be connected into the centralized liquid cooling system. Quick connect couplers are often used to couple the hoses to the manifold because they can be installed without tools and because they automatically prevent the fluid from spilling out of the hoses when they are disconnected from the manifold during repair or routine service operations. The problem with using such couplers, however, is that they are very difficult to disconnect when located in recessed or hard-to-reach locations. For example, when used in blade server enclosures, quick connect couplers are frequently located in recessed spaces that house the manifold and external hoses. Because such spaces are surrounded by protruding edges and crowded with manifold parts, external hoses, and multiple quick connect couplers, attempting to disconnect any one particular quick connect coupler by manually manipulating its outer sleeve can be extremely challenging.

Others have previously attempted to solve this problem by designing specially-adapted tools for extending into hard-to-reach locations and retracting the outer sleeve of the female member. One tool, for example, is essentially a long metal, stand-alone tool and separate flange with one or more bent distal ends that include two semicircular voids. To use the tool, a user must wedge the distal end into the recessed region and twist it so that the semicircular voids align with the outer sleeves of multiple female members. In practice, the tool is cumbersome, difficult to use, and infrequently provides a successful disconnect on the first attempt. Having to repeatedly attempt to disconnect quick connect couplers using the long, metal stand-alone tool is time consuming and ultimately frustrates the very purpose of using them in the first place. Moreover, having to purchase and maintain a stock of a single-purpose tool is disadvantageous in and of itself because it increases cost and storage requirements associated with using the quick connect couplers.

Users facing related issues in the electrical industry have attached clip-on straps to difficult-to-reach electrical connectors. Such connectors, however, feature snap-in connection mechanisms. The clip-on straps are used to release a catch. As described above, quick connect couplers feature a unique engagement system. Accordingly, such straps are not compatible with quick connect couplers.

In short, there is a need in the art for an improved quick connect coupler disengagement mechanism that aids users in rapidly disengaging quick connect couplers, especially those located in recessed, crowded, or otherwise difficult-to-reach spaces.

### SUMMARY

The rapid disengagement extension mechanism of the present invention provides for improved disengagement of a quick connect coupler, particularly when the coupler is located in a recessed, crowded, or otherwise difficult-to-reach area. The rapid disengagement extension mechanism includes a pull member coupled to an outer sleeve of a female member of a quick connect coupler. The pull member extends rearwardly from the coupler into a space that provides better maneuverability for disengaging the coupler with a finger or hand. Accordingly, the rapid disengagement extension mechanism allows a user to easily and rapidly disengage a quick connect coupler without the use of a cumbersome and difficult-to-use tool, even when the coupler would otherwise be very difficult to reach. In an embodiment, the pull member may be directly integrated into the outer sleeve of the female member. In another embodiment, the pull member may be coupled to an annular collar that couples to an existing female member of a standard quick connect coupler.

An embodiment of the coupler engagement mechanism may include a female member of a quick connect coupler and a pull member. The female member of the quick connect coupler may detachably couple to a corresponding male member of a quick connect coupler. The female member may include a central axis opening and a telescopically slidable outer sleeve. The outer sleeve may be spring-biased in a forward direction towards the central axis opening. The pull member may be coupled to the outer sleeve and extend rearwardly from the outer sleeve.

An embodiment of the coupler engagement mechanism may include an annular collar and a pull member. The annular collar may couple to the telescopically slidable outer sleeve of a female member of a quick connect coupler. The pull member may be coupled to the annular collar and may extend rearwardly from the annular collar.

An embodiment of the coupler engagement mechanism may include a first member of a connect coupler and a second member. The first member of the connect coupler may detachably couple to a corresponding receiving member of a connect coupler. The first member may include an outer sleeve. The second member may be coupled to the outer sleeve and may extend rearwardly past an outer sleeve. The second member may be engaged by a user to attach the first member to the receiving member.

### BRIEF DESCRIPTION OF DRAWINGS

FIG. 1A illustrates a quick release coupler and a socket disengaged.

FIG. 1B illustrates a quick release coupler and a socket partially engaged.

FIG. 1C illustrates a quick release coupler and a socket completely engaged.

FIG. 2 illustrates a blade server enclosure connected to hoses utilizing a quick release connection mechanism.

FIG. 3 is a perspective view of an exemplary coupler engagement mechanism in accordance with the present invention.

FIG. 4 is a top view of another exemplary coupler engagement mechanism in accordance with the present invention.

FIG. 5 is a perspective view of the coupler engagement mechanism in use within a blade server enclosure.

### DETAILED DESCRIPTION

A coupler engagement mechanism is provided. The rapid disengagement extension mechanism of the present invention provides for improved disengagement of a quick connect coupler, particularly when the coupler is located in a recessed, crowded, or otherwise difficult-to-reach area. The rapid disengagement extension mechanism includes a pull member that is coupled to an outer sleeve of a female member of a quick coupler. The pull member extends rearwardly from coupler into a space that provides better maneuverability for disengaging the coupler with a finger or hand. As a result, the rapid disengagement extension mechanism is extremely advantageous because it allows a user to easily and rapidly disengage a quick connect coupler without the use of a cumbersome and difficult-to-use tool, even when the coupler would otherwise be very difficult to reach.

FIG. 3 is a perspective view of an exemplary coupler engagement mechanism in accordance with the present invention. In an embodiment, a coupler engagement mechanism 300 may include a female member 310 that detachably couples to a corresponding male member (not shown). Female member 310 may include a central axis opening 320 and a telescopically slidable outer sleeve 330. Outer sleeve 330 may be spring-biased in a forward direction towards central axis opening 320. A pull member 340 may be coupled to outer sleeve 330. Pull member 340 may be coupled to outer sleeve 330 directly or through intermediate components. For example, pull member 340 may be directly integrated into outer sleeve 330 or a formed extension of outer sleeve 330. Alternatively, pull member 340 may be coupled to outer sleeve 330 through an intermediate clamp, tie, snap, or other suitable coupling mechanism. Pull member 340 may extend rearwardly from outer sleeve 330. Pull member 340 may be designed and implemented to extend out of a recessed channel or other difficult to reach area within an enclosure, such as a blade server enclosure with multiple hoses (as shown in FIGS. 2 and 5).

Pull member 340 obviates the need to use a cumbersome and difficult to use tool to disengage female member 310 from a corresponding male member of a quick connect coupler. Namely, the user can simply use a finger, where pull member 340 includes a loop, or multiple fingers on one hand, where pull member 340 may not include a loop, to apply a rearward force to pull member 340 in a direction away from opening 320. Because it is coupled to outer sleeve 330, pull member 340 transfers the applied rearward force to outer sleeve 330. As a result, pull member 340 forces outer sleeve 330 into its unbiased rearward position. Once in its unbiased position, an internal locking obstruction (not shown) of female member 340 momentarily recedes into opening 320 away from a circumferential groove in the corresponding male member (not shown). Because the internal locking obstruction of female member 310 is disengaged from the circumferential groove of the male member, female member 310 is disengaged as a whole and may be pulled free from the male member.

Once the female and male couplers are disengaged the collar does not need to be released to prevent spilling/dripping. The internal parts of the couplers (sometimes referred to as poppets) ensure that no spilling occurs as soon as the two parts are disengaged, regardless of the female coupler collar position.

Pull member 340 may be a wire, hose, strap, or any other member capable of extending rearwardly from outer sleeve 330. Pull member 340 may be made from metal, plastic, wood, or any other known material with the minimal rigidity required for extending rearwardly from outer sleeve 330. Coupler engagement mechanism 300 may further include an additional annular member 350 that helps to reduce slack and keep pull member 340 taut for optimal extendibility.

FIG. 4 is a top view of another exemplary coupler engagement mechanism in accordance with the present invention. In another embodiment, a coupler engagement mechanism 400 may include an annular collar 410 that couples to a telescopically slidable outer sleeve 420 of a female member 430 of a quick connect coupler. A pull member 440 may be coupled to annular collar 410. Pull member 440 may extend rearwardly from annular collar 410. Pull member 440 may extend out of a recessed channel or other difficult to reach area within an enclosure, such as a blade server enclosure (as shown in FIG. 5).

Coupler engagement mechanism 400 may be snapped on, screwed on, tied to, fitted over, or coupled in any other suitable manner to an existing quick connect coupler. Pull member 440 may be a wire, hose, strap, or any other member capable of extending away from outer sleeve 420. Pull member 440 may be made from metal, plastic, wood, or any other known material with the minimal rigidity required for extending rearwardly from outer sleeve 420. Coupler engagement mechanism 400 may further include an additional annular member 450 that helps to reduce slack and keep pull member 440 taut for optimal extendibility. For example, annular member 450 may be a strap, clamp or other mechanism that maintains pull member 440 in close proximity to an outer surface of a hose or other device to which mechanism 400 is coupled to.

The materials, dimensions, and coupling mechanism selected for various embodiments of coupler engagement mechanism 400 may depend on any of several design considerations, such as for example the size, style, and materials used by the manufacturer of the standard quick connect coupler of interest. In various embodiments, the length or diameter of pull member 440 may depend on the anticipated use of the associated quick connect coupler (e.g., whether it will be used within deep or shallow recessed channels, or used in a space crowded by short or tall objects). Various configurations and combinations of materials, dimensions, and coupling mechanisms may be selected to create a comprehensive product line of coupler engagement mechanisms 400 that are suitable for use with many different quick connect couplers made by many different manufacturers.

Once a standard quick connect coupler is fitted with coupler engagement mechanism 400, pull member 440 obviates the need to use a cumbersome and difficult to use tool to disengage female member 430 from a corresponding male member of a quick connect coupler. Namely, the user can simply use a finger, where pull member 440 includes a loop, or multiple fingers on one hand, where pull member 440 does not include a loop, to apply a rearward force to pull member 440 in a direction away from the opening (not shown) of female member 430. Because pull member 440 is coupled to annular collar 410, and because annular collar 410 is coupled to outer sleeve 420 of female member 430, the rearward force applied to pull member 440 is transferred to outer sleeve 420 through annular collar 410. As a result, outer sleeve 420 is forced rearward into its unbiased position.

Once in its unbiased position, an internal locking obstruction (not shown) of female member 430 momentarily recedes into the opening of female member 430 and away from a circumferential groove in the corresponding male member (not shown). Because the internal locking obstruction of female member 430 is disengaged from the circumferential groove of the male member, female member 430 is disengaged as a whole and may be pulled free from the male member.

FIG. 5 is a perspective view of the coupler engagement mechanism of FIG. 4 in use within a blade server enclosure. The quick connect coupler 500 is positioned within recessed space 510, as is common within enclosures such as blade server enclosure 520. A male member 530 of quick connector coupler 500 is coupled to a manifold 540 on one end and a female member 550 of quick connector 500 on the opposite end. An annular collar 560 is coupled to a telescopically slidable outer sleeve 570 of female member 550. A pull member 580 is coupled to annular collar 560. Female member 540 is coupled to a hose 590. An additional annular member 595 is also shown coupled to hose 590 over pull member 580. Additional annular member 595 helps to reduce slack and keep pull member 580 taut for optimal extendibility.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A coupler engagement mechanism, comprising:
a female member of a quick connect coupler that detachably couples to a corresponding male member of a quick connect coupler, the female member including:
a central axis opening, and
a telescopically slidable outer sleeve, the outer sleeve being spring-biased in a forward direction towards the central axis opening; and
a pull member coupled to the outer sleeve, the pull member extending rearwardly from the outer sleeve.

2. The coupler engagement mechanism of claim 1, wherein the pull member includes a wire.

3. The coupler engagement mechanism of claim 1, wherein the pull member is coupled to a hose.

4. The coupler engagement mechanism of claim 1, wherein the pull member includes a strap.

5. The coupler engagement mechanism of claim 1, further comprising an annular member that constrains the pull member against a hose to reduce slack and keep the pull member taut for optimal extendibility.

6. A coupler engagement mechanism, comprising:
an annular collar that couples to the telescopically slidable outer sleeve of a female member of a quick connect coupler; and
a pull member coupled to the annular collar, the pull member extending rearwardly from the annular collar.

7. The coupler engagement mechanism of claim 6, wherein the pull member includes a wire.

8. The coupler engagement mechanism of claim 6, wherein the pull member includes a hose.

9. The coupler engagement mechanism of claim 6, wherein the pull member includes a strap.

10. coupler engagement mechanism of claim 6, wherein the annular collar is made from metal.

11. The coupler engagement mechanism of claim 6, wherein the annular collar is made from plastic.

12. The coupler engagement mechanism of claim 6, wherein the annular collar is made from an elastic material.

13. The coupler engagement mechanism of claim 6, further comprising an annular member that constrains the pull member against a fluid communication member to reduce slack and keep the pull member taut for optimal extendibility.

14. A coupler engagement mechanism, comprising:
a first member of a connect coupler that detachably couples to a corresponding receiving member of a connect coupler, the first member including an outer sleeve; and
a second member coupled to the outer sleeve, the second member extending rearwardly past an outer sleeve, the second member engaged by a user to attach the first member to the receiving member.

15. The coupler engagement mechanism of claim 14, wherein the pull member includes a wire.

16. The coupler engagement mechanism of claim 14, wherein the pull member is coupled to a hose.

17. The coupler engagement mechanism of claim 14, wherein the pull member includes a strap.

18. The coupler engagement mechanism of claim 14, further comprising an annular member that constrains the pull member against a hose to reduce slack and keep the pull member taut for optimal extendibility.

19. The coupler engagement mechanism of claim 14, wherein a material is transferred through a coupling formed by the first member and the receiving member.

20. The coupler engagement mechanism of claim 19, wherein the material is a fluid.
